(19) United States
(12) Patent Application Publication
(10) Pub. No.: US 2008/0148399 A1
(43) Pub. Date: Jun. 19, 2008

(54) Protection against stack buffer overrun exploitation

(75) Inventor: Patrick Winkler, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/583,277

(22) Filed: Oct. 18, 2006

(51) Int. Cl. G06F 12/14

(52) U.S. Cl. 726/22

(57) ABSTRACT

Stack buffer overrun situations may be handled by a computer program that checks the memory location from where a particular function is called. As long as the return address for the function call is from a memory location of a known library that is loaded in memory, normal operation continues. If the memory location is not from a known library, the function call is suspect and execution may be terminated, since such a location may cause malicious software to be executed or abnormal program execution to happen. The memory location may also be verified by additional means, including testing whether the memory page permissions permit execution. The computer program may be a plug-in to an existing application and may also have a user-editable component. The computer program can enable a quick deployment of a temporary fix to a malicious software problem before a more permanent solution may be deployed.

### BACKGROUND

Buffer overrun vulnerability is a condition in computer security where a computer process may be redirected to an unintended area where it may crash or be caused to execute malicious code. The malicious code may be any type of computer code that may damage the computer system or otherwise wreak havoc with computers, networks, and data. Many types of buffer overrun conditions exist.

A stack buffer is used when a subroutine or function is called. The stack buffer may contain an address location to which execution returns after a function is called. In some cases, a function call may be changed by forcing a stack buffer overrun condition and changing an address location in the stack buffer. This may cause execution to be redirected to malicious software or execution may halt unintentionally.

### SUMMARY

Stack buffer overrun situations may be handled by a computer program that checks the memory location from where a particular function is called. As long as the return address for the function call is from a memory location of a known library that is loaded in memory, normal operation continues. If the memory location is not from a known library, the function call is suspect and execution may be terminated, since such a location may cause malicious software to be executed or abnormal program execution to happen. The memory location may also be verified by additional means, including testing whether the memory page permissions permit execution. The computer program may be a plug-in to an existing application and may also have a user-editable component. The computer program can enable a quick deployment of a temporary fix to a malicious software problem before a more permanent solution may be deployed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a pictorial illustration of an embodiment showing a system for monitoring function calls.

FIG. 2 is a flowchart illustration of an embodiment showing a method for correcting a security problem.

FIG. 3 is a flowchart illustration of an embodiment showing a method for checking return addresses.

FIG. 4 is a flowchart illustration of an embodiment showing a method for keeping track of allowable memory locations.

### DETAILED DESCRIPTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

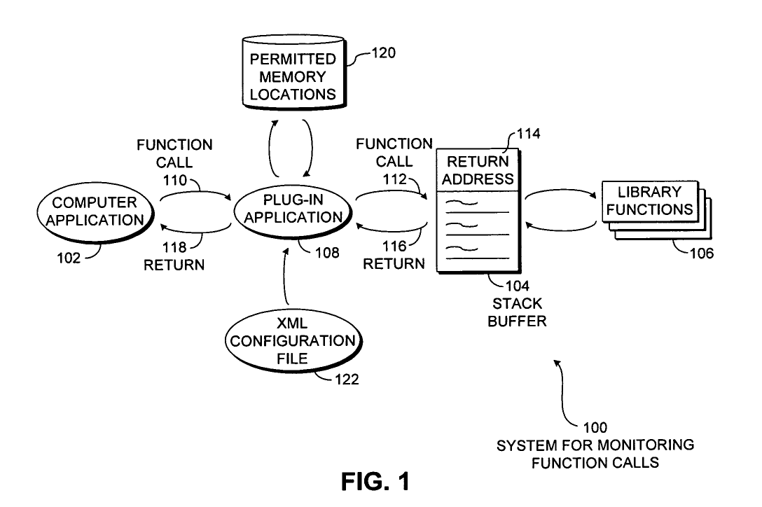

FIG. 1 is a diagram of an embodiment 100 showing a system for monitoring function calls. A computer application 102 stores information in a call stack 104 in order to call a subroutine or other function in a function library 106. A plug-in application 108 operates between the computer application 102 and the buffer or call stack 104 to verify the return address 114. In operation, the computer application 102 makes a function call 110, which may be monitored by the plug-in application 108, and is sent 112 to the stack buffer 104. After the function has completed, execution is returned to the return address 114, which is returned 116 and intercepted by the plug-in application 108.

The plug-in application 108 verifies the return address 114 is within a database of permitted memory locations 120. If the return address 114 does indeed point to a permitted memory location, execution is returned 118 to the computer application 102 and the computer application 102 operates normally. If the return address 114 is outside of the permitted memory locations 120, execution is halted.

In some embodiments, the plug-in application 108 may verify the return address 114 prior to allowing the library function 106 to execute, while in other embodiments, the plug-in application 108 may verify the return address 114 after the library function 106 has executed. Further embodiments may also perform the verification task in parallel to the execution of the library function 106.

Embodiment 100 is a mechanism by which a return address 114 in a stack buffer 104 may be intercepted and verified before execution continues. The return address 114 may be checked in several different ways so that obvious misdirection of program execution may be identified and stopped. The plug-in application may be used as a temporary or permanent solution to a buffer overflow security risk.

When a buffer overflow condition exists, the stack buffer 104 may be corrupted. One method for gaining unauthorized access to a computer system is to exploit such a condition by forcing the return address 114 to point to a malicious code that may be present on a computer system. Viruses, worms, and other forms of malicious software may exploit buffer overrun conditions in this manner.

The plug-in application 108 keeps track of the memory locations for the executable portions of the computer application 102. When a return address 114 points to a location within the executable portions of the computer application 102, the return address 114 is assumed to be proper. In addition, other checks may also be performed on the return address 114, including checking whether the memory block to which the return address 114 points is an executable memory location as opposed to a non-executable memory location.

The plug-in application 108 can be easily implemented when a security breach becomes known. The XML configuration file 122 may contain the name of the function call 110 to monitor and the plug-in application 108 may be operational to halt damage that may be caused by malicious software that exploit a buffer overrun condition using that particular function call. The configuration file 122 may also specify one or more types of checks that are performed on the function call 110. The configuration file 122 may be any form of information storage that defines the function call to be tracked. In some embodiments, the function call may be hard coded into the plug-in application 108, while in other embodiments, the function call may be stored in a manner that it may be easily changed. In some embodiments, several function calls may be monitored or tracked in this manner.

In many cases, a computer application vulnerability may become known but a robust fix for the problem may take several days or even weeks to be properly identified, make changes to the computer application 102, and thoroughly test the changes before distributing the changes to an installed base of users. While the plug-in application 108 does not address the inherent problem in the computer application 102 that enabled a buffer overrun condition, the plug-in application 108 may provide an easily-deployable solution that may provide a temporary fix until a more robust solution can be delivered. In some cases, the function call 110 may not be related to the actual long-term fix made to the computer application 102 or library functions 106, but may be merely a detectable symptom of the vulnerability.

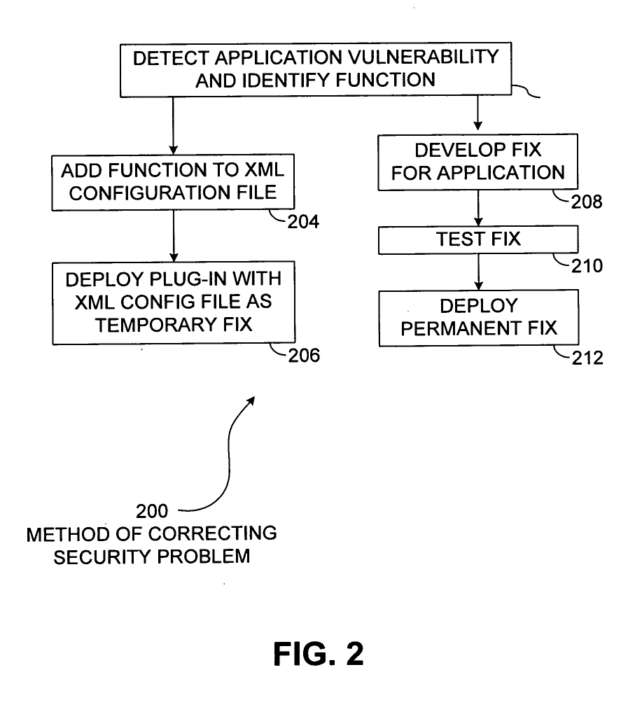

FIG. 2 is a flowchart illustration of an embodiment 200 of a method for correcting a security problem. When a vulnerability is detected in a computer application, a specific function call may be identified in block 202. As a short term solution, the function call may be added to an XML or other editable configuration file in block 204, and the plug-in application and configuration file may be distributed as a temporary fix in block 206.

Simultaneously, a robust fix for the application may be developed in block 208 and rigorously tested in block 210. Once tested, a permanent fix may be deployed in block 212.

When dealing with a computer application vulnerability, especially with large computer applications, a substantial amount of time may be required to pinpoint the vulnerability and develop a patch that adequately corrects the vulnerability. In addition, extensive testing may be required to verify that the fix is complete. In some instances, the time to implement a solid fix may be several weeks or even months. By deploying a temporary fix in the form of the plug in application discussed herein, the immediate threat may be diminished and the application developer may have less pressure to implement a fix.

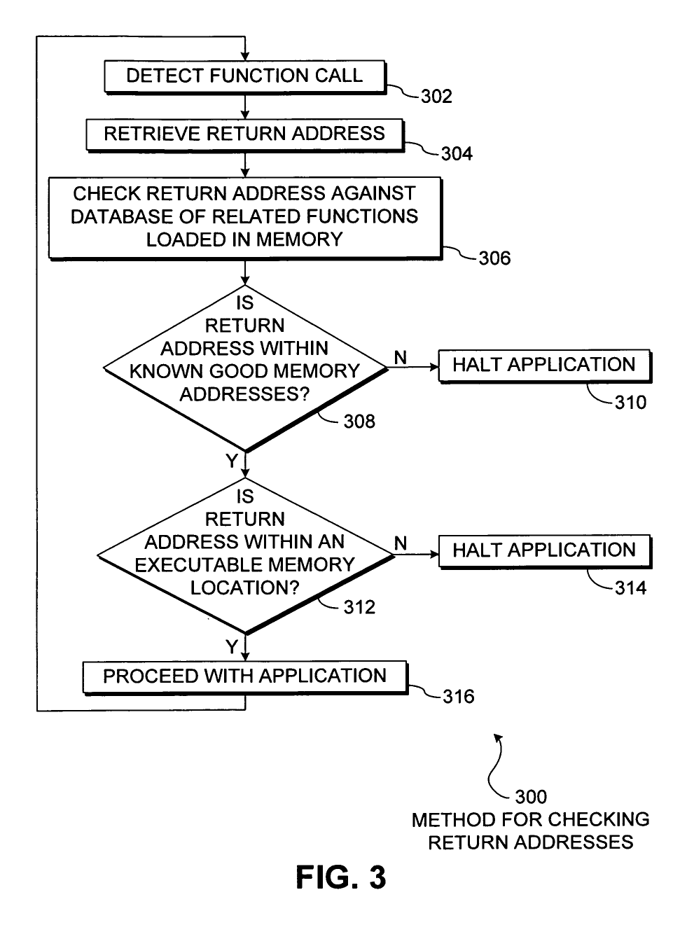

FIG. 3 is a flowchart illustration of an embodiment 300 showing a method for checking return addresses. The function call is detected in block 302 and the return address is retrieved in block 304. The return address is checked against a database of related functions loaded in memory in block 306. If the return address is not within the known good memory addresses in block 308, the application is halted in block 310. If the return address is within known good memory addresses in block 308, another check is performed. If the return address is not within an executable memory address in block 312, the application is halted in block 314. If the return address is within an executable memory address in block 312, the application proceeds normally in block 316 and the process returns to block 302.

Embodiment 300 is one method by which a return address can be verified before execution transfers back to the calling routine. Execution is permitted to return to the return address when the return address is within the known good memory locations and that memory location is an executable memory location. In some embodiments, the checks on the memory location may be performed when the function call is made, while in other embodiments, the checks may be performed when the function has completed execution. The known good memory locations are those locations where the calling application resides, as well as any other library is loaded that is associated with the application. If a stack buffer overflow situation exists, program execution may be attempted to be transferred outside of the application code and into a malicious program. By making sure the return address points to the application code, malicious code may be detected when a stack buffer overflow condition exists.

In some embodiments, the application may be halted in blocks 310 and 314 automatically or with the user input. When a security threat is known to compromise an application through a specific function call, it may be advisable to have the application terminate immediately before malicious software causes any problem with the system. In some instances, a dialog box may appear that details the problem and gives the user a choice to continue. In other embodiments, data about the problem may be captured and stored for later review. In such an embodiment, the user may be given an opportunity to report the problem to a central server where such problems may be tracked.

Some computer systems have a mechanism by which some memory may be designated as “executable” and other memory as “non-executable”. In such systems, the processor may halt any process that attempts to execute instructions that may be located in a non-executable area. Some processors may adhere to such a protocol, while other processors running the same software may not. Some malicious software may reside in such non-executable areas and attempt to exploit security vulnerabilities by causing program execution to point to code within non-executable memory locations.

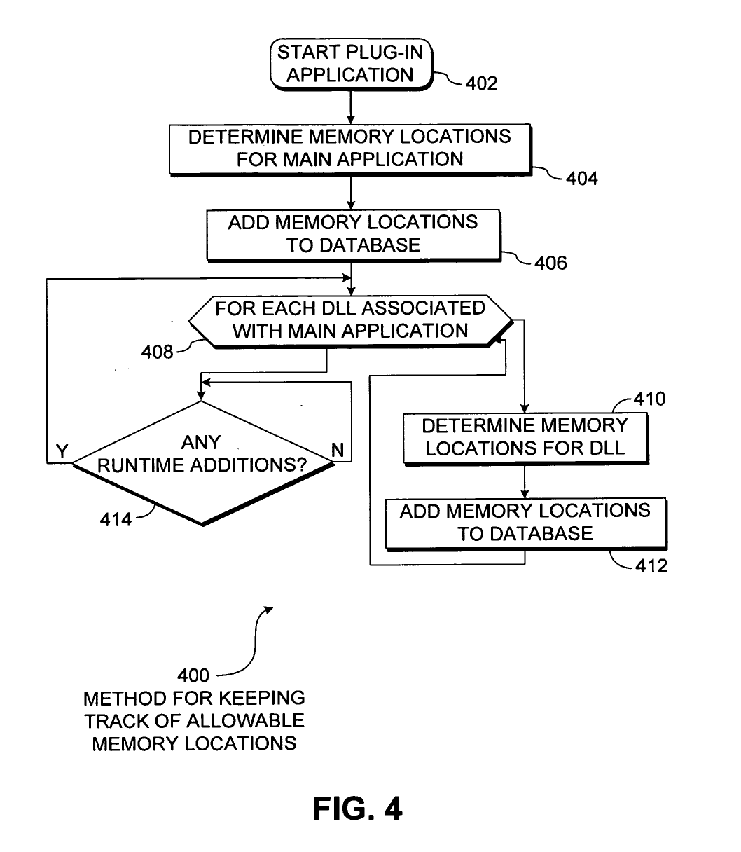

FIG. 4 is a flowchart illustration of an embodiment 400 showing a method for keeping track of allowable memory locations. The embodiment 400 is a method that may create and maintain the database of permitted memory locations 120 illustrated in FIG. 1.

The application plug-in is started in block 402. The memory location for the main application is determined in block 404, and the memory locations are added to the database in block 406. For each dynamic linked library or other library function associated with the main application in block 408, the memory locations are defined in block 410 and added to the database in block 412. If any runtime additions to the libraries are made in block 414, the process repeats at block 408.

The embodiment 400 illustrates one method by which the memory locations associated with a specific application may be gathered and tracked. A small database may be kept that defines the bounds of all the memory locations associated with the application. Dynamic linked libraries and other libraries of functions may be loaded and unloaded during the execution of the application, and the memory locations may also be updated. Various applications may be written with various structures for library functions or other mechanisms for segregating the functionality and memory requirements of an application. Similar methods may be used to keep track of the current allowable memory locations for an application.

Embodiment 400 may be used to keep track of the allowable memory locations so that a return address may be quickly looked up in the database without having too much of an impact on the performance of the application. In some situations, the database 120 and method 400 may be eliminated if another method were used to determine if the return address 114 was pointing to an allowable memory location.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
determining a security problem in a first computer executable code, said problem comprising a callable executable function;
operating a second computer executable code in parallel with said first computer executable code, said second computer executable code adapted to:
detect that said first computer executable code has called said callable executable function;
detect a memory location from where said callable executable function was called;
determine whether said memory location was within a set of permitted memory locations; and
halt execution if said memory location is not within said set of permitted memory locations.

2. The method of claim 1 wherein said library comprises an application programming interface.

3. The method of claim 1 wherein said executable function is comprised in an operating system.

4. The method of claim 1 wherein said step of halt execution is performed prior to executing said executable function.

5. The method of claim 1 wherein said second computer executable code is further adapted to:
detect that said memory location is within an executable memory location.

6. The method of claim 1 wherein said second computer executable code is a plug-in application.

7. The method of claim 1 wherein said second computer executable code comprises an executable portion and a changeable portion.

8. The method of claim 7 wherein said changeable portion comprises editable text strings.

9. A method comprising:
executing a first computer executable code on a computer processor, said first computer executable code having a function call to a function located in a library module loaded into memory;
executing a second computer executable code in parallel with said first computer executable code, said second computer executable code adapted to:
detect that said first computer executable code has called said executable function;
detect a memory location from where said executable function was called; and
allow said executable function to be executed if said memory location is associated with said library.

10. The method of claim 9 wherein said library comprises an application programming interface.

11. The method of claim 9 wherein said executable function is comprised in an operating system.

12. The method of claim 9 wherein said memory is volatile memory.

13. The method of claim 9 wherein said second computer executable code is further adapted to:
detect that said memory location is within an executable memory location.

14. The method of claim 9 wherein said second computer executable code is a plug-in application.

15. The method of claim 9 wherein said second computer executable code comprises an executable portion and a changeable portion.

16. The method of claim 15 wherein said changeable portion comprises editable text strings.

17. A system comprising:
a computer processor;
volatile memory accessible by said computer processor;
a library comprising an executable function, said library being loaded into said volatile memory;
a first computer executable code comprising a call to said executable function;
a second computer executable code adapted to:
detect that said first computer executable code has called said executable function;
detect a memory location from where said executable function was called; and
allow said executable function to be executed if said memory location is associated with said library.

18. The method of claim 9 wherein said executable function is comprised in an operating system.

19. The method of claim 9 wherein said second computer executable code is further adapted to:
detect that said memory location is within an executable memory location.

20. The method of claim 9 wherein said second computer executable code is a plug-in application.
